(19) United States
(12) Patent Application Publication
(10) Pub. No.: US 2019/0232991 A1
(43) Pub. Date: Aug. 1, 2019

(54) Foldable Vehicle and Wheel-Frame Locking Assembly Thereof

(71) Applicant: Smacircle Technology (Shenzhen) Co., Ltd., Shenzhen (CN)

(72) Inventor: Ming Li, Shenzhen (CN)

(73) Assignee: Smacircle Technology (Shenzhen) Co., Ltd., Shenzhen (CN)

(21) Appl. No.: 16/312,169

(22) PCT Filed: Jul. 4, 2017
(86) PCT No.: PCT/CN2017/091607

§ 371 Date: Dec. 20, 2018

(30) Foreign Application Priority Data
Jul. 11, 2016 (CN) 201610544333.X
Jul. 11, 2016 (CN) 201620728046.X

(51) Int. Cl. B62B 3/02; B62B 1/04

(52) U.S. Cl. CPC B62B 3/022; B62B 1/042

(57) ABSTRACT

Provided are a wheel-frame locking assembly of a foldable vehicle, and a foldable vehicle using said wheel-frame locking assembly. The wheel-frame locking assembly comprises a fork (1), said fork being provided with a first pin hole; a wheel frame; the end of the connection between the wheel frame (1) and the fork is provided with a sleeve (2); By means of the sleeve (2), the wheel frame is rotatably sleeved on the fork (1); the sleeve (2) is provided with a second pin hole fitting the first pin hole, and when the wheel frame is opened to a use state, the second pin hole aligns with the first pin hole, a positioning member arranged on the fork (1) and preventing the wheel frame from falling off the fork (1); a lock pin (6) fitted with the first pin hole and the second pin hole and used for locking and unlocking the wheel frame to and from the fork (1). The wheel frame locking assembly enables a foldable vehicle to be further folded, and the wheel frame rotates around the fork (1), then the folding of the wheel frame itself is accomplished, thus the space occupied by the foldable vehicle after folding is further reduced effectively improving the portability of the foldable vehicle.

This application claims the priorities of the Chinese patent application filed on Jul. 11, 2016 and submitted to the Chinese Patent Office, the application number is 201610544333.X, and the invention name is “A foldable vehicle and wheel-frame locking assembly thereof” and of the Chinese patent application submitted to Chinese Patent Office on Jul. 11, 2016 and entitled “A foldable vehicle and wheel-frame locking assembly thereof”, the entire contents of which are incorporated herein by this reference.

### BACKGROUND OF THE INVENTION

### 1. Field of the Invention

The present invention relates to the field of foldable vehicle production technology, and more particularly, to a foldable vehicle and its wheel-frame locking assembly thereof.

### 2. Description of the Prior Art

Taking a bicycle as an example, the wheel frame includes a front wheel frame and a rear wheel frame, the front wheel of the bicycle is mounted on the front wheel frame which is mounted on the front fork of the bicycle; the rear wheel of the bicycle is mounted on the rear wheel frame mounted on the rear fork of the bicycle. The front fork and the rear fork are collectively referred to as the fork of the bicycle.

With the improvement of people's living standards and the lifestyle demands, the foldable vehicles suitable for urban short-distance travel and which are easy to carry are becoming more and more the choice of consumers. However, the current foldable vehicles can only be folded in the middle of the vehicle, and the folded vehicle occupies about half of the original volume, but this still has the problem that the occupied space of the vehicle is too large and difficult to carry.

Therefore, how to further reduce the space occupied by the foldable vehicle and improve the portability of the vehicle are technical problems that those skilled in the art urgently need to solve.

### SUMMARY OF THE INVENTION

In view of this, one of the objects of the present invention is to provide a wheel-frame locking assembly for a foldable vehicle, so as to further reduce the space occupied by the foldable vehicle after folding, and improve the portability of the vehicle.

Another object of the present invention is to provide a foldable vehicle employing the above-described wheel-frame locking assembly.

To achieve the above objects, the present invention provides the following technical solutions:

A wheel-frame locking assembly for a foldable vehicle, comprising:

a fork, with a first pin hole opened on the fork;

a wheel frame, wherein one end of the wheel frame, connected to the fork, is provided with a sleeve, and the wheel frame movably surrounds the fork by the sleeve, and the sleeve is opened and arranged a second pin hole that cooperates with the first pin hole, and the second pin hole is aligned with the first pin hole when the wheel frame is unfolded to the use state;

a positioning member disposed on the fork and preventing the wheel frame from falling off the fork;

a lock pin cooperating with the first pin hole and the second pin hole and for locking and unlocking the wheel frame on the fork.

Preferably, the fork comprises a fork body, and a mandrel disposed at an end of the fork body and having a diameter smaller than the fork body. The sleeve surrounds the mandrel.

Preferably, the positioning member is a positioning screw connected to an end of the mandrel, and a nut of the positioning screw is used for limiting the sleeve.

Preferably, the positioning member is a circlip provided at an end of the mandrel.

Preferably, the first pin hole is a through-hole formed in the fork, and when the wheel frame is deployed to a use state, the second pin hole is aligned with one end of the first pin hole; the second pin hole is aligned with the other end of the first pin hole when the wheel frame is rotated to the folded state.

Preferably, a pin hole cover is disposed at the second pin hole, and the lock pin is disposed on the pin hole cover, wherein, one end of the locking pin extends into the second pin hole, the other end passes through the pin hole cover, and one end of the locking pin located in the second pin hole is provided with a shoulder; one end of the return spring surrounding the locking pin abuts the shoulder, and the other end abuts the pin hole cover; a knob that is hinged to the locking pin and that is bent out from one end of the pin hole cover, the knob is provided with an eccentric protrusion, and when the eccentric protrusion is opposite to the pin hole cover, the lock pin is completely retracted into the second pin hole. The lock pin is inserted into the first pin hole and the second pin hole when the remaining position of the knob is opposite to the pin hole cover.

Preferably, the pin hole cover is screwed to the sleeve.

Preferably, the locking pin is a screw threadadly connected to the second pin hole.

Preferably, the fork is a bicycle front fork, and the wheel frame is a bicycle front wheel frame.

The foldable vehicle disclosed in the present invention includes a wheel-frame locking assembly, and the wheel frame locking assembly is always the wheel frame locking assembly disclosed in any of the above.

It can be seen from the above technical solution that in the wheel frame locking assembly disclosed in the present invention, a first pin hole is opened in the fork, a sleeve is arranged at one end of the wheel frame cooperating with the fork, and the wheel frame can be rotatably surrounding the fork through the sleeve. The sleeve is provided with a second pin hole that cooperates with the first pin hole. When the wheel frame is deployed to the use state, the second pin hole is aligned with the first pin hole, and the lock pin can lock the wheel frame on the fork to ensure the normal use of the foldable vehicle; when folding and the locking pin is pulled out, the wheel frame can be rotated relative to the fork; compared with the prior art, the foldable vehicle allows further folding, the wheel frame is rotated around the fork to allow the folding of the wheel frame itself, which can further reduce the space occupied by the foldable vehicle after folding, thereby effectively improving the portability of the foldable vehicle.

### BRIEF DESCRIPTION OF THE DRAWINGS

In order to more clearly illustrate the embodiments of the present invention or the technical solutions in the prior art, the drawings used in the embodiments or the description of the prior art will be briefly described below. Obviously, the drawings in the following description are only some embodiments of the present invention, and other drawings can be obtained from those skilled in the art without any creative work.

FIG.1 is a schematic structural view of a front wheel frame of a foldable vehicle disclosed in an embodiment of the present invention;

FIG. 2 is a partial cross-sectional view of FIG. 1;

FIG. 3 is an enlarged view of a partial position of FIG. 2;

FIG. 4 is a schematic structural view of the locking member of FIG. 2 in an unlocked state;

FIG. 5 is a schematic structural view of the front wheel frame of the foldable vehicle in the folded state according to the embodiment of the present invention.

Wherein, 1 is a fork, 2 is a sleeve, 3 is a pin hole cover, 4 is a knob, 5 is a return spring, 6 is a lock pin, 7 is a set screw, and 8 is a tire.

### DETAILED DESCRIPTION OF THE PREFERRED EMBODIMENTS

One of the objects of the present invention is to provide a wheel frame locking assembly for a foldable vehicle, so as to further reduce the space occupied by the foldable vehicle after folding, and improve the portability of the vehicle.

Another object of the present invention is to provide a foldable vehicle employing the above-described wheel frame locking assembly.

The technical solutions in the embodiments of the present invention are clearly and completely described in the following with reference to the accompanying drawings in the embodiments of the present invention. It is obvious that the described embodiments are only a part of the embodiments of the present invention, instead of all embodiments. All other embodiments obtained by those skilled in the art based on the embodiments of the present invention without creative efforts are within the scope of the present invention.

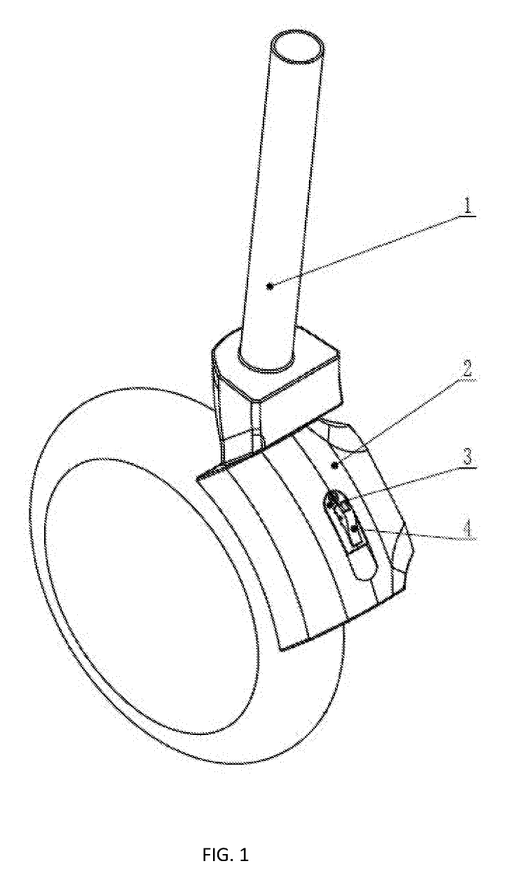

Referring to FIG. 1 to FIG. 5, the wheel frame locking assembly of the foldable vehicle disclosed in the present invention includes a fork, a wheel frame, a positioning member and a lock pin, wherein the fork is provided with a first pin hole. One end of the wheel frame cooperating with the fork is provided with a sleeve, with the wheel frame is rotatably surrounded on the fork by the sleeve, and the sleeve is provided with a second pin hole that is aligned with the first pin hole. When the wheel frame is unfolded to the use state, the second pin hole is aligned with the first pin hole. As shown in FIG. 1, the positioning member is disposed on the fork and its function is to prevent the wheel frame from falling off the fork, and the lock pin is used for coupling the first pin hole and the second pin hole, and the lock pin can lock the wheel frame on the fork or unlock the wheel frame from the fork.

It can be seen from the above embodiment that a first pin hole is opened in the fork, a sleeve is arranged at one end of the wheel frame cooperating with the fork, and the wheel frame is rotatably surrounded on the fork through the sleeve. A second pin hole is formed to cooperate with the first pin hole and is opened in the sleeve, and when the wheel frame is deployed to the use state, the second pin hole is aligned with the first pin hole, and the lock pin can extend through the first pin hole and the second pin at this time and then lock the wheel frame on the fork to ensure the normal use of the foldable vehicle; when the foldable vehicle needs to be folded, the lock pin is pulled out, and the wheel frame can be rotated relative to the fork. Compared with the prior art, the foldable vehicle allows further folding, and the wheel frame is rotated around the fork to allow the folding of the wheel frame itself, which can further reduce the space occupied by the foldable vehicle after folding, thereby effectively improving the portability of the foldable vehicle.

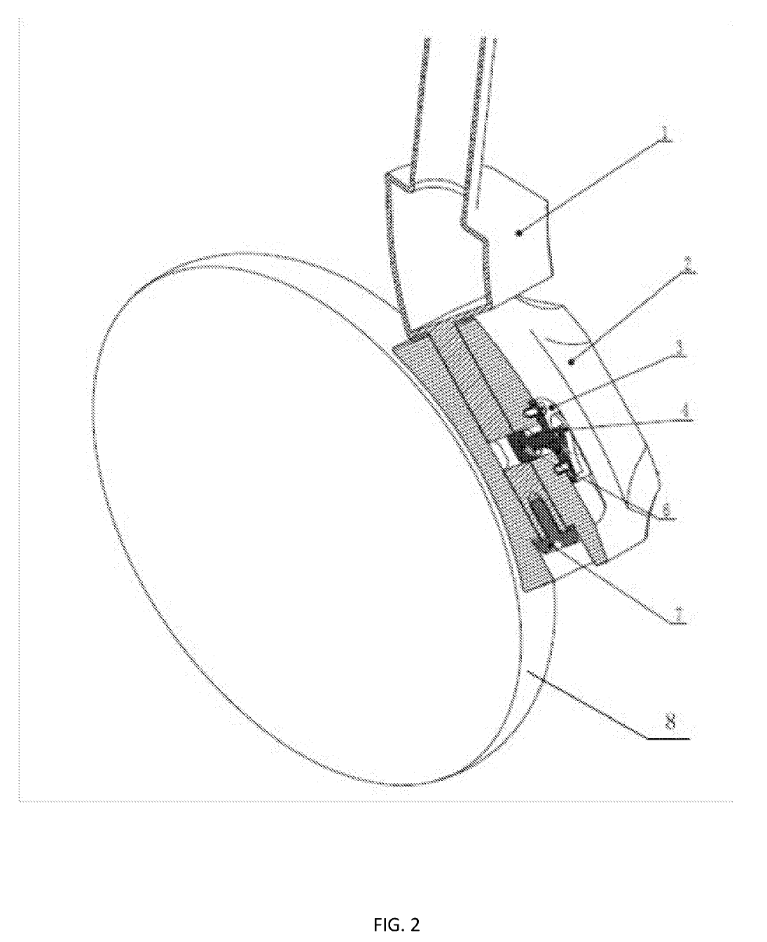

Referring to FIG. 2 to FIG. 4, the fork of the embodiment includes a fork body and a mandrel disposed at an end of the fork body. The diameter of the mandrel is smaller than that of the fork body, and the sleeve surrounds the mandrel. The setting of the mandrel makes the installation of the wheel frame and the fork more convenient. Further, the contact portion of the mandrel and the sleeve is also provided with a stainless steel washer or a high-strength self-lubricating plastic washer to reduce the friction between the sleeve and the mandrel.

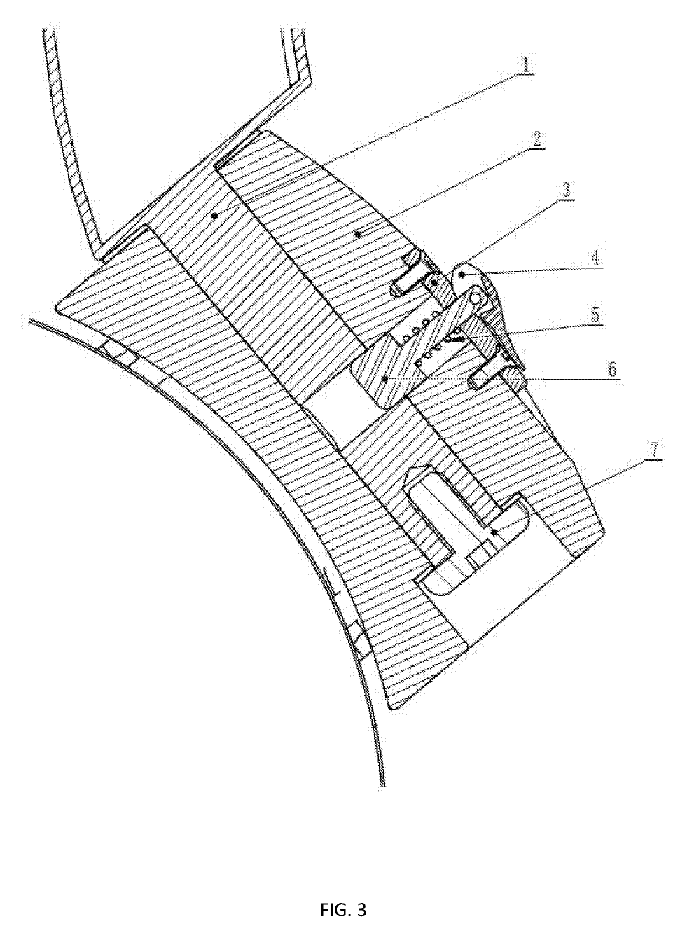

It will be readily understood by those skilled in the art that the positioning member for positioning the sleeve can have various options. For example, in one embodiment of the invention, the positioning member is specifically a set screw threadably connected to the end of the mandrel. As shown in FIG. 3, the nut of the set screw is used to limit the sleeve. Of course, in order to reduce the friction between the set screw and the sleeve, a self-lubricating plastic washer can be added between the nut of the set screw and the sleeve. In another embodiment, the positioning member may also be a circlip fixedly disposed at the end of the mandrel, and the hem of the circlip is used to restrict the sleeve from coming off the mandrel. Further, in this embodiment, the first pin hole is a through-hole formed in the fork, and when the wheel frame is deployed to the use state, the second pin hole is aligned with one end of the first pin hole, and when the wheel frame rotates to the folded state, the second pin hole is aligned with the other end of the first pin hole, and then the lock pin can pass through the first pin hole and the second pin hole at this time and lock the wheel frame on the fork, which ensures the stability of the wheel frame in the folded state and prevents it from rotating in the folded state.

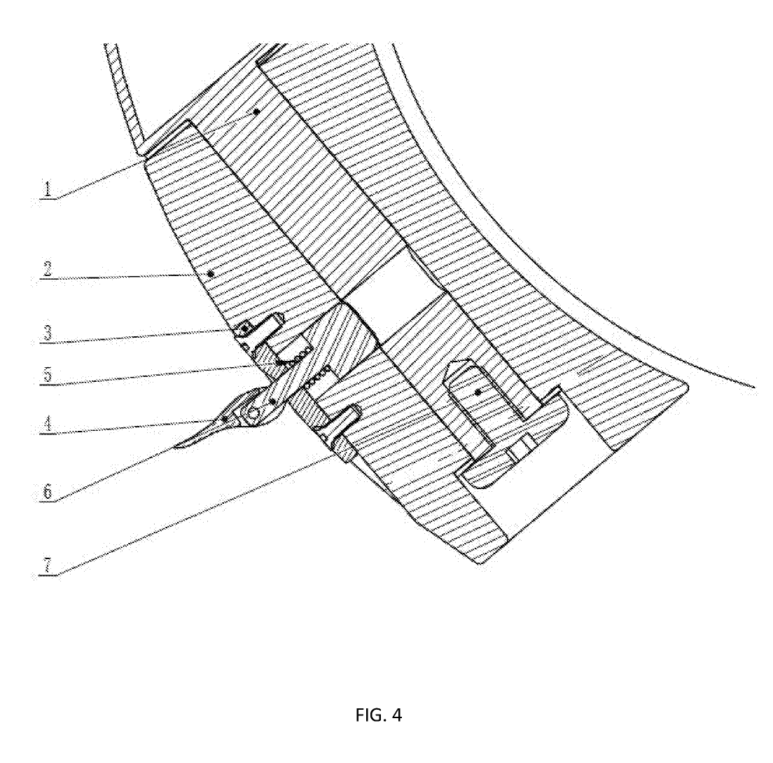

Referring to FIG. 3 and FIG. 4, the second pin hole in the embodiment is provided with a pin hole cover, the pin hole cover covers the second pin hole, and the lock pin is disposed on the pin hole cover, specifically, one end of the lock pin extends into the second pin hole, and the other end passes through the pin hole cover, and the end of the locking pin located in the second pin hole is further provided with a shoulder. One end of the return spring surrounds the locking pin and abuts the shoulder, and the other end is opposite to the pin hole cover. The end of the locking pin passing through the pin hole cover is hinged with a knob, and the knob is provided with an eccentric protrusion, when the eccentric protrusion is opposite to the pin hole cover, the lock pin can be lifted and fully pushed into the second pin hole. At this time, the wheel frame can rotate freely with respect to the fork, as shown in FIG. 4. When the rest part of the knob is in contact with the pin hole cover, under the action of the return spring, the locking pin is simultaneously inserted into the first pin hole and the second pin hole to allow the locking of the wheel frame on the fork, as shown in FIG. 3.

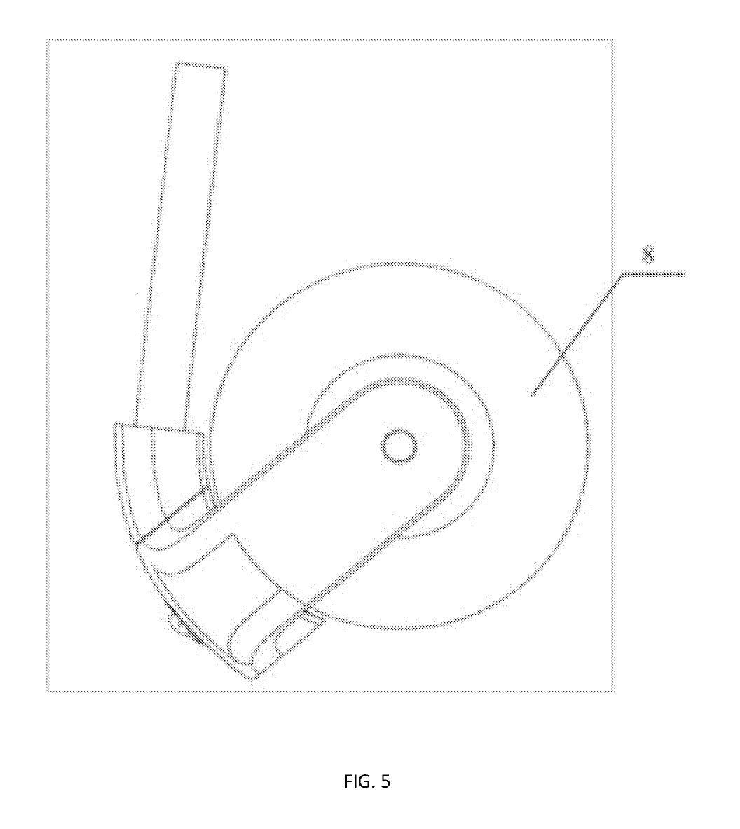

As shown in FIG. 3, when the wheel frame is deployed to the use state, the lock pin extends into the first pin hole and the second pin hole to lock the wheel frame, and when the wheel frame rotates 180° and reaches the folding state, as shown in FIG. 5, the lock pin extends from the other end of the first pin hole, and locks the wheel frame again to ensure the stability of the wheel frame in the folded state.

The pin hole cover and the sleeve may be a screw thread connection, a screw connection or a snap connection. In the embodiment of the invention, the pin hole cover and the sleeve are connected by screw, as shown in FIGS. 2 to 4.

In the embodiment of the present invention, a locking method of the locking pin is also disclosed. In the embodiment, the locking pin is specifically a screw, the front end of the screw is used for extending into the first pin hole, and the second half is used for threadadly cooperating with the second pin hole. When the lock is required, the screw is threaded into the second pin hole and screwed tightly to ensure that the front end thereof extends into the first pin hole for locking; when unlocking is required, the screw is rotated and loosened, or directly screwed out of the second pin hole, to prevent it from being inserted into the first pin hole and the second pin hole at the same time.

The forks disclosed in the above embodiments may each be a front fork or a rear fork of the foldable vehicle, and correspondingly, the wheel frame is a front wheel frame or a rear wheel frame of the foldable vehicle.

In addition, the present invention also discloses a foldable vehicle including, but not limited to, a bicycle, a scooter, etc., which employs the wheel frame locking assembly disclosed in any of the above embodiments.

Because the above-mentioned wheel frame locking assembly is adopted, the foldable vehicle has the corresponding technical advantages of the above-mentioned wheel frame locking assembly, which will not be further described herein.

The various embodiments in the present specification are described in a progressive manner, and each embodiment focuses on differences from other embodiments, and the same similar parts between the various embodiments may be referred to each other.

The above description of the disclosed embodiments enables those skilled in the art to make or use the invention. Various modifications to these embodiments are obvious to those skilled in the art, and the general principles defined herein may be implemented in other embodiments without departing from the spirit or scope of the invention. Therefore, the present invention will not to be limited to the embodiments shown herein, but is to accord with the broadest scope consistent with the principles and novel features disclosed herein.

1. A wheel frame locking assembly for a foldable vehicle, characterized in that, comprising:
a fork (1), the fork (1) provided with a first pin hole;
a wheel frame, an end of the wheel frame connecting with the fork (1) is provided with a sleeve (2), and the wheel frame rotatably surrounds the fork (1) through the sleeve (2), the sleeve (2) is provided with a second pin hole that cooperates with the first pin hole, and when the wheel frame is deployed to the use state, the second pin hole is aligned with the first pin hole;
a positioning member disposed on the fork (1) and preventing the wheel frame from falling off the fork (1);
a lock pin cooperating with the first pin hole and the second pin hole and for locking and unlocking the wheel frame on the fork (1).

2. The wheel frame locking assembly of claim 1, wherein the fork (1) comprises a fork body and a mandrel disposed at an end of the fork body and having a diameter smaller than fork body, wherein the sleeve (2) surrounds the mandrel.

3. The wheel frame locking assembly of claim 2, wherein the positioning member is a set screw (7) that is screwed to an end of the mandrel, and a nut of the set screw (7) is used to limit the sleeve (2).

4. The wheel frame locking assembly of claim 2, wherein the positioning member is a circlip disposed at an end of the mandrel.

5. The wheel frame locking assembly of claim 1, wherein the first pin hole is a through hole formed in the fork (1), when the wheel frame is deployed to the use state, the second pin hole is aligned with one end of the first pin hole; the second pin hole is aligned with the other end of the first pin hole when the wheel frame is rotated to the folded state.

6. The wheel frame locking assembly of claims 1 to 5, wherein the second pin hole is provided with a pin hole cover (3), and the locking pin (6) is arranged on the pin hole cover (3), wherein one end of the locking pin (6) extends into the second pin hole, the other end passes through the pin hole cover (3), and the end of the locking pin (6) located in the second pin hole is provided with a shoulder; wherein one end of the return spring (5) surrounding the locking pin (6) abuts the shoulder, and the other end abuts the pin hole cover (3); wherein one end of the locking pin (6) passing through the pin hole cover (3) is hinged with a knob (4), and the knob (4) is provided with an eccentric protrusion, and when the eccentric protrusion abuts the pin hole cover (3), the locking pin (6) is completely retracted into the second pin hole, and when the remaining position of the knob (4) and the pin hole cover (3) is in the event of abutment, the locking pin (6) is inserted into the first pin hole and the second pin hole.

7. A wheel frame locking assembly of claim 6, wherein the pin hole cover (3) is screwed to the sleeve (2).

8. A wheel frame locking assembly of claim 1, wherein the locking pin (6) is a thread that is threadadly coupled to the second pin hole.

9. A wheel frame locking assembly of claim 1, wherein the fork (1) is a bicycle front fork and the wheel frame is a bicycle front wheel frame.

10. (canceled)
